(19) United States
(12) Patent Application Publication
(10) Pub. No.: US 2007/0106585 A1
(43) Pub. Date: May 10, 2007

(54) A system and method of financing through the preservation of principal (pop)

(76) Inventor: William N. Miller, Renton, CA (US)

Correspondence Address: JEFFREY FURR, 253 N. MAIN STREET, JOHNSTOWN, OH, 43031, US

(21) Appl. No.: 11/164,208

(22) Filed: Nov. 14, 2005

Related U.S. Application Data
(60) Provisional application No. 60/522,841, filed on Nov. 12, 2004.

(51) Int. Cl. G06Q 40/00

(52) U.S. Cl. 705/36 R

(57) ABSTRACT

The current invention creates a financial structure has two distinct components. The first component of the structure is that it allows an investor to pay for, or exchange for, partnership interests with something other than cash, including low basis securities, defined as any security that has large unrealized capital gains, and/or Restricted Stock, as defined by Rule 144 of the Securities Act of 1933/34, as amended. The second component of the structure is that the partnership operates under a “Preservation of Principal” concept in which some or all of the investor's capital contribution to the partnership is protected from financial risk. This mitigation of risk is created using a portion of contributed funds, before the application of proceeds. The manner of protection is accomplished at the time the partnership either monitizes or uses the contributed securities as collateral. The techniques of Preservation of Principal may include, but are not limited to, the use of sophisticated option strategies, combination positions that may include shorting stock “against the box” coupled with the purchase of discounted securities, or other hedged, or arbitraged positions that provide protection to the investor's capital contribution in the event of project failure.

### BACKGROUND OF INVENTION

The invention relates a system and method of financing using a preservation of principal.

During the past few years it has become apparent that there is a move toward requiring government agencies to reduce or control the spending of tax dollars to fund municipal projects. In addition to public pressure to conserve, lawmakers have had to face voter wrath because of constant reports in the press concerning the mounting deficits created by years of borrowing and conflicts over which projects deserve state and municipal financial support. Combined, these events have resulted in a financial crisis for many government organizations.

While forcing fiscal responsibility is beneficial in theory, it has also created a quagmire in application. A held Stadium Development Conference in San Francisco highlighted the differences between public and private fund raising techniques. Attended by owners of professional sports teams, lawyers, financial advisors, and municipal dignitaries, the conference presented many of the financing formulas that might be applied to the capitalization of municipal projects. Despite the positive tone of a majority of the keynote speakers, there were a few disturbing revelations. The most significant was that private organizations were experiencing difficulty penetrating the bureaucratic layers of municipal government. In fact, with the exception of the huge corporate and legal conglomerates who had substantial resources and long standing connections with legislators, many smaller companies with good ideas came to the conclusion that the arduous process of dealing in the public sector was simply too time consuming and costly to pursue.

Most municipalities have limited resources, large deficits, and angry taxpayers demanding fiscal responsibility. Further, there is a direct correlation between a municipality's degree of success or failure in funding projects to the ability of the municipal leaders to manage capital resources. Surprisingly, it was found that those legislators who were the most creative, or took the non-standard approach to funding, were the most successful at solving the financial problems in their communities.

It is clear that the root of the problem in municipal finance is a dependence upon taxes. While legislators have a tremendous amount of creativity in utilizing taxes, there was virtually no understanding of alternative financing methods that did not have a tax component. The assumption was that taxes are available, don't have to be paid back, and can be raised if necessary.

Many government officials, rather than find something new and innovative in raising capital, simply rework what has been done before. This is usually accomplished in one of two ways:

Move revenues from one source to cover a shortfall in another.

For example, many municipalities will increase gas, cigarette or so called “sin” taxes to help defray the cost of “worthwhile” projects. By reallocating funds in this manner legislators can then show their constituents that they are against certain areas such as smoking, gas guzzling, drinking etc., while being sympathetic to other areas such as conservation, education, and better roads.

The problem occurs when the legislator fails to recognize that an increase in the sin taxes might sometimes ends up altering the spending habits of the so called sinners to a point that revenues actually decrease across the board.

Create a new source of revenue based on a previously successful source.

For example, a major West Coast city, prior to building a new football stadium, created a special lottery to help defray construction costs. The thought was that this new lottery would garner support by those who favored the project and not be a burden to those in opposition. What legislators failed to recognize was that their constituents fell into one of two categories. Either they did, or did not like to play the lotto. The new lottery not only failed to attract those who normally wouldn't play a lottery, but in fact, drew people away from the states main lottery, a premier source of revenue for the state. In short, the special lottery ended up being a direct competitor with the state's main lottery thereby creating a “zero net gain”.

The majority of municipal representatives rely almost exclusively on past historical data when determining potential revenues and expenses for a project. The propensity to assume that the past will project indefinitely into the future creates an unforeseen problem. The municipality fails to factor in the unexpected that happens with surprising regularity. For example, the municipality builds a new football stadium based on the revenues of the previous stadium, only to have the team lose its franchise and move to another city. Additionally, the process of looking to the past leaves little room for developing new funding alternatives that lack a historical basis required by the municipality in factoring projections.

There was a time in history when there was no government deficit. Taxes were paid, and government provided services based on the amount of funds available. Today the issuance of debt has become so prevalent that many states and municipalities are faced with the proposition that if tax revenues continued unabated, yet all spending stopped, it would still take years to recover from the debt that has been accumulated.

This problem begins when a project requires funding at a time when there is insufficient money available from the state or municipality's General Fund. Rather than raise taxes, or cut spending in other areas, the state or municipality issues debt (municipal bonds) with the assumption that the debt can be paid back over a period of time. Similar to an irresponsible consumer buying large ticket item on a credit card when there is insufficient resources to buy the item outright, the decision to get into debt is based on the belief that future income will be sufficient to pay the principal and interest. If income fails to meet expectations, difficulties arise. Even worse, the problem is further compounded when legislators believe that the state or municipality can always raise taxes, reallocate funds, or issue new debt to pay off the old debt.

None of this would be a problem if legislators only issued periodic debt. However, what usually happens is that a state or municipality will factor all the income from taxes and other sources, and determine that it can incur debt, as long as the yearly debt service requirements are no more than the amount of income available. Like “leveraging” in the stock market, this process does not provide sufficient latitude to cover new project requirements, or an unplanned reduction in income.

In the private sector there is usually a clearly defined executive who is capable of making all decisions regarding the funding aspects of a given project. This individual is capable of (a) reviewing reports, (b) determining the value of an idea, and most importantly, (c) initiating the process of implementation. Therefore, if an outside organization has a good idea it can approach the decision-maker quickly and efficiently.

In the public sector, decision lines became clouded. While the public ultimately owns a municipal project, there are multiple layers of decision-makers elected to act on behalf of the public, each who may have the ability to influence the outcome of any funding approach. This inherent inefficiency in locating a knowledgeable decision-maker can prevent good ideas from being presented to the right people. Unless the organization approaching the state or municipality has pre-existing connections, or an enormous amount of time and money to spend locating the right decision-maker(s), the process of dealing with a government entity can be too costly to attempt. This is especially true of small companies with limited resources who tend to be at the forefront of developing new concepts.

Generally, legislators tend to spend their time dealing with the political aspects of government and are usually not in a position to study or learn the complexities of finance. Most rely upon the advice of outside experts. Further, in order to overcome a lack of financial expertise, many legislators believe that the best approach is to form a “Task Force” to review potential funding alternatives.

While a seemingly logical solution, problems still arise, especially when Task Force members have been appointed based upon political aspects, i.e., individuals who have influence in the community, rather than financial expertise. In such cases, legislators fail to recognize that lawyers, accountants, doctors, successful business owners, or wealthy individuals, while possessing expertise in their individual fields, may not have any real financial experience in solving government problems. In addition, how does a legislator, who may have limited financial expertise him or herself, judge the expertise of a potential advisor or Task Force member? Most simply go off the recommendation of other legislators or previous advisors thereby perpetuating the flawed process.

In addition to appointing non-experts to a Task Force, there are also problems associated with relying on outside experts for advice, i.e., investment bankers, brokers, and municipal specialists. This is especially true when the “experts” make such a clear distinction between public and private funding concepts that they fail to see how private formulas can be altered to fit public financing needs.

In the past, this was not much of a problem, as most financial experts were trained in multiple disciplines. However, in recent years the trend in the financial community is toward specialization. While having specialized departments is beneficial in theory, it has led to a fragmentation of expertise. There are few “generalists” anymore who understand the full scope of finance, and can review new ideas in one area, and alter concepts to fit individual circumstances in another area. For example, in most major financial institutions (banks, brokerage houses, investment banking firms, etc.) the Corporate Finance Department has been effectively separated from Municipal Finance Department, which has been further separated from the Trading Department, Government Bond Department, Managed Wealth Department, Restricted Stock Department, etc. If a new idea comes out of one department, it is likely to remain cloistered. Therefore, when legislators look to major brokerage firms or financial institutions as “experts” they are likely to be given to an “expert” whose only scope is in the area of municipal finance, who has neither the experience or time to review concepts generated from other areas.

The problems of fragmentation described above are further magnified when legislators possess the attitude that all municipal funding concepts have already been developed, and further, any exploration outside of what has been previously accomplished is either dangerous or not worth pursuing. It is surprising how often statements were made by so called municipal experts such as “I've never heard of that approach”, or “We would have to see someone else use the approach before we would consider it.” Even when a particular approach had proven itself as viable in the private sector, many legislators still said, “Yes, but it has never been used in municipal financing.” Because of this stagnant attitude new concepts are seldom brought to the table, and those that are, run the risk of “dying on the vine.”

There is another even more insidious problem related to getting legislators to consider new funding ideas. Because a person is voted into political office, few are willing to take a chance on supporting something that may appear out of the realm of the status quo. The attitude is “one can't be faulted by following proven techniques, even if they fail.”

One of the biggest hurdles private companies must overcome when dealing with public entities is the fact that every few years elections cause changes. This leads to a myriad of problems. Projects that took years to plan and develop can be shelved overnight because a new administration has a different vision of the value of the project. Even if the same political party remains in office, changes in individual legislators and the makeup of oversight committees may be altered. The project developer may have to educate new legislators, wait for political alliances to be formed, prepare additional rounds of reports, and attend extra meetings. All this increases costs and uses up time. This is why so few companies specialize in government projects.

The following is a simplified review of the main funding sources currently used to capitalize government projects. While not intended to be a complete dissertation on each area it should provide an educational overview.

Municipal Bonds

Municipal bonds (sometimes referred to a “Muni's”) are debt obligations issued by states, cities, counties, and other governmental entities to raise money to build schools, highways, hospitals, and sewer systems, as well as many other projects for the public good. The issuance of either “Revenue Bonds” or “General Obligation Bonds” allows funds to be raised from private sector investors. As debt instruments the bonds require the municipality to: Repay all of the borrowed funds, by a predetermined maturity date, and Make scheduled interest and principal payments during the life of the bonds, usually on a semi-annual basis.

A “Revenue” bond is issued under the condition that a given project's revenues will support the repayment of principal and interest, whereas a “General Obligation” Bond utilizes the full taxing authority of the municipality as the basis of repayment.

Because municipal bonds help fund government projects, the IRS allows the interest income to be free of taxes. From the investor's standpoint, even though the interest earned is less than an equally rated corporate bond, the tax-free interest feature can offer the high tax bracket investors higher after tax returns. From the municipality's standpoint, because the dollar amount of actual interest to be paid is less than would otherwise be required if the bonds did not have such government sponsored tax benefits, it is able to save interest expense for the issuing municipality. In short, the issuance of municipal bonds enables municipalities to borrow funds from investors at lower interest rates while still being attractive to private investors who are in higher income tax brackets.

The drawbacks to this type of funding are:

1. Municipal Bonds must pay a return to investors from the effective date of issuance, even though there may be no offsetting income available until after a project has been completed and/or tax dollars or user fees are generated. (For example, a light rail system may take years to build before there are any revenues earned) Therefore, the project either has to dip into principal, or the project requires the use of federal, city, or state funds as an augmentation—which typically requires voter approval.

2. The principal must be paid back at maturity. In the case of a Revenue Bond, steady cash flow from the project cannot always be exactly determined up front or guaranteed. If the income is insufficient to pay the interest plus principle, the bond could come due without the means to pay back the investors (retire the debt). This might require a new round of financing, or an increase in taxes, either of which could be difficult to secure. At the very least, the investor's money could be put at risk, a point that makes most Revenue bonds less attractive than General Obligation bonds.

In the case of a General Obligation Bond, the full taxing authority of the government entity supports the issue. While there may be offsetting income generation, depending upon the type of project, the mainstay of the repayment comes from future taxes. If the project does not have an income, or the income is insufficient to pay off the bond, the burden will ultimately fall on the taxpayers.

3. Municipal bonds must compete with other bonds for investor dollars. As such, if a particular municipality is less attractive than another, it may have difficulty raising funds. The only solutions may be to either: (a) raise the amount of interest that is paid to investors in order to make the bond more attractive, which is detrimental to the municipality that needs the funds, or (b) over-collateralize the bonds, which may reduce the ability to borrow funds in the future, or lower the overall credit rating of the municipality.

4. Municipal bonds, like any bond, are sensitive to interest rate fluctuations. The old financial rule of thumb is that as interest rates go up—bond prices go down, or, as interest rates decline—bond prices go up. During periods of low interest rates there is a real risk that interest rates could rise thereby causing the bond to depreciate in value. The investor may then be faced with either selling the bond at a loss, or having to hold the bond to maturity while receiving less income than others receive. This possibility can make municipal bonds less attractive to investors.

Municipal Bonds are not only interest sensitive and highly dependent upon market conditions, but owe their success as a capital source to the economic viability of the municipality in which they are issued. Depending upon the tax base of the municipality, there may be a limit as to how many municipal bonds can be issued at a given time. Further, as debt, they add to the strain put on government while creating performance requirements that many projects or municipalities cannot satisfy. Should the repayment of principal or interest be less than successful, the impact on future offerings can be severe, or the issuing municipality may jeopardize its credit rating. Also, in smaller municipalities where ratings may not be as strong, the issuance of Municipal bonds may not be available as a viable funding alternative.

Taxation

Utilization of a municipality's tax base is the most prevalent method of funding public projects. As an oversimplification of the process, (a) the municipality requires its residents and businesses to pay a portion of their income to the municipality in the form of a tax, (b) tax revenues are deposited into a general account, and (c) the municipality disperses funds from the general account to a specific account which is then used to pay for a needed project. While taxation may seem an easy solution to funding, as the money does not have to be paid back, there are some inherent drawbacks:

1. The main problems occur when current projects are too massive in size, too numerous, or where present income sources in the municipality are insufficient to meet the funding requirements. The solutions used most often, are to (a) borrow against future revenues, (b) increase taxes, (c) reallocate taxes, or (d) approach outside entities for funding support. The tendency to increase or reallocate taxes, or leverage available funds by increasing debt would work if it were not for the fact that while current projects are being funded off of these machinations, new projects are constantly being added. Eventually, the requirements become so large that the only solutions are to raise taxes, lower services, or reduce the number of projects, all of which negatively affect the residents of the municipality.

2. Costly pre-accounting, report preparation, and public forums must be completed in order to insure the public understands the proposed disposition of funds.

3. The state or municipality must constantly justify how it spends tax dollars, even after the project has been implemented. This increases the possibility of lawsuits or bad publicity, and at the very least, increases legal, public relations, and accounting expenses.

Coops

Cooperative Public/Private Funding is based upon a financial plan initiated in either the private or public sector in which a consortium of companies or individuals attempt to fund a project through a joint venture or cooperation agreement with a city or state government organization or agency. (Examples include many of the newly constructed sports stadiums). The main drawbacks to this type of financing are threefold:

1. The state or municipality must support the majority of the project from funds generated by tax dollars. This depletes general fund reserves, and may require tax increases. At a time of voter resistance to such increases, approval may be difficult.

2. The project must generate sufficient income and/or profits to offset project costs. If the public does not support the project by paying taxes, or the project itself is less than profitable, the total project could be delayed, or require additional financial support.

3 The project revenues are usually shared in a manner that is less than attractive to the municipality. While there are exceptions, in most cases the owner of the project restricts revenue distributions until after the owners obligations have been satisfied. In addition, the owner may impose other conditions, ultimately at the expense of the taxpayer.

In conclusion, there are solutions to all the problems mentioned above. Alternative financing is available that is not dependent upon taxes or debt. Experts are accessible who can create solutions to complex problems. Most importantly, municipalities can formulate project implementation procedures that provide viable access to new ideas and additional capital resources. There are only three things that are needed. Municipalities must want to improve current conditions, be willing to explore new ideas, and, have the foresight to plan ahead.

There is still room for improvement in the art.

### SUMMARY OF THE INVENTION

The POP concept is based on the utilization of financial structures, commonly referred to as a Private Placements, Limited Partnerships, or LLC's (Limited Liability Company or Corporation), used in the process of raising capital to finance private, public, or charitable projects, or used to finance private asset purchases, coupled with financial techniques designed to mitigate risk, and/or increase profit potential, income, and flexibility

The current invention creates a financial structure that has two distinct components.

The first component of the structure is that it allows an investor to pay for, or exchange for, partnership interests with something other than cash, including low basis securities, defined as any security that has large unrealized capital gains, and/or Restricted Stock, as defined by Rule 144 of the Securities Act of 1933/34, as amended.

The second component of the structure is that the partnership operates under a “Preservation of Principal” concept in which some or all of the investor's capital contribution to the partnership is protected from financial risk. This mitigation of risk is created using a portion of contributed funds, before the application of proceeds. The manner of protection is accomplished at the time the partnership either monitizes or uses the contributed securities as collateral. The techniques of Preservation of Principal may include, but are not limited to, the use of sophisticated option strategies, combination positions that may include shorting stock “against the box” coupled with the purchase of discounted securities, or other hedged, or arbitraged positions that provide protection to the investor's capital contribution in the event of project failure.

The utility and technical advantages of this invention will be readily apparent to one skilled in the art from the following figures, description, and claims.

Definitions

The term “Private Placement” as used in this description refers to the offer and sale of any security not involving a public offering. Private offerings are not the subject of a registration statement filed with the SEC under the 1933 Act. Private placements are done in reliance upon Sections 3(b) or 4(2) of the 1933 Act as construed or under Regulation D as promulgated by the SEC, or both.

The term “Limited Partnership” as used in this description is defined as a partnership that is composed of one or more persons who control the business of a partnership and may be personally liable for the partnership's debts and one or more other persons who contribute capital and share profits but cannot manage the business and are only liable for the amount of their investment.

The term “LLC” or Limited Liability Company or Corporation, as used in this description is defined as a business structure that is a hybrid of a partnership and a corporation. Its owners are shielded from personal liability and all profits and losses pass directly to the owners without taxation of the entity itself.

The term financial techniques as used in this description are defined as the use of hedging and arbitrage that may include option purchases and sales, combination positions such as option “collars,” “Variable Forward Sales,” “Prepaid Forward Sales,” and other techniques such as “Shorting Against the Box”, discounted security purchases, equity swaps, option writing, and option spreads.

### BRIEF DESCRIPTION OF DRAWINGS

Without restricting the full scope of this invention, the preferred form of this invention is illustrated in the following drawings:

FIG. 1 displays step 1 of the process;

FIG. 2 displays step 2 of the process;

FIG. 3 displays step 3 of the process; and

FIG. 4 shows the final process.

### DETAILED DESCRIPTION

The following description is demonstrative in nature and is not intended to limit the scope of the invention or its application of uses.

There are a number of significant design features and improvements incorporated within the invention.

The POP concept is based on the utilization of financial structures, commonly referred to as a Private Placements, Limited Partnerships, or LLC's (Limited Liability Company or Corporation), used in the process of raising capital to finance private, public, or charitable projects, or used to finance private asset purchases, coupled with financial techniques designed to mitigate risk, and/or increase profit potential, income, and flexibility.

The term “Private Placement” as used in this description refers to the offer and sale of any security not involving a public offering. Private offerings are not the subject of a registration statement filed with the SEC under the 1933 Act. Private placements are done in reliance upon Sections 3(b) or 4(2) of the 1933 Act as construed or under Regulation D as promulgated by the SEC, or both.

The term “Limited Partnership” as used in this description is defined as a partnership that is composed of one or more persons who control the business of a partnership and may be personally liable for the partnership's debts and one or more other persons who contribute capital and share profits but cannot manage the business and are only liable for the amount of their investment.

The term “LLC” or Limited Liability Company or Corporation, as used in this description is defined as a business structure that is a hybrid of a partnership and a corporation. Its owners are shielded from personal liability and all profits and losses pass directly to the owners without taxation of the entity itself.

The term financial techniques as used in this description are defined as the use of hedging and arbitrage that may include option purchases and sales, combination positions such as option “collars,” “Variable Forward Sales,” “Prepaid Forward Sales,” and other techniques such as “Shorting Against the Box”, discounted security purchases, equity swaps, option writing, and option spreads.

Under the POP concept the financial structure has distinct components. They will include no less than two of the following:

The POP financial structure enables an investor to pay for, or exchange for, partnership interests or shares of stock in a private placement, limited partnership or LLC with something other than cash, including low basis securities, defined as any security that has large unrealized capital gains, and/or Restricted Stock, as defined by Rule 144 and Rule 145 of the Securities Act of 1933/34, as amended, and/or any combination of stock and cash.

The POP financial structure enables the partnership to operate under a “Preservation of Principal” methodology defined as a process in which some or all of the investor's capital contribution to the partnership is protected from financial risk, from either a decline in the underlying contributed security, or from project failure. This mitigation of risk is created using a portion of contributed funds, before or after the application of proceeds in the project itself, to purchase protection of the investor's or contributor's initial capital contribution. The protection may occur at the time the partnership first monitizes or uses the contributed securities or combination of securities and cash as collateral, or at a later date at the discretion of the partnership or LLC management and/or at the discretion of the fund manager or financial consultant advising project or fund management. The techniques of Preservation of Principal may include, but are not limited to, the use of sophisticated option strategies, such as put option purchases, option “collars,” variable forward sales “VFS's,” “prepaid forward sales,” or any variation thereof, and other combined positions that may include shorting stock “against the box,” the purchase of discounted securities, or other hedged, or arbitraged positions that provide protection to the investor's capital contribution.

The POP financial structure enables the partnership to include a “convertibility” feature that enables the investor or contributor the alternative to “re-invest” or “re-contribute” securities or cash, back into the partnership or LLC in anticipation of an Initial Public Offering (sometimes referred to as an IPO), and/or a merger, acquisition, or takeover by another company, LLC, or partnership. This feature enables the investor to participate in the leveraging of assets that may result from the process of an IPO, merger, acquisition, or takeover.

The POP financial structure enables the partnership and or LLC to employ sophisticated investment strategies including the use of both put and call options, rights, or warrants, discounted securities purchases, or other sophisticated investment techniques in order to provide the investors in the partnership or LLC some percentage of upside potential should the underlying contributed securities increase in value during the time the securities are being used for an investment in the Private Placement, limited partnership, or LLC.

The POP concept is based on the use of a financial structure, commonly referred to as a Private Placement or Limited Partnership, used in the process of raising capital to finance private, public, or charitable projects.

Generally, funding problems can be solved either though alternative money management techniques or from new sources of outside capital that help offload project capital requirements. Each of the solutions, when combined in a conservative manner, allow the state or municipality to accomplish the goals of preserving principal, increasing revenues, and allowing more projects to be funded with the same dollars.

One of the most unique financial concepts being suggested is based on a concept called “Preservation of Principal.” The “POP” basic premise is simple—spend only income earned from principal, not the principal itself.

Few seem to recognize that once principal is lost, it must be replenished. Further, when principal is used as collateral for leveraging purposes, as in the case where a municipality pledges future revenues in order to fund more projects through debt, the long term financial health of the municipality is jeopardized Further, while beneficial in theory, applying the “POP” concept on a wide scale is difficult to implement. Most municipalities do not have (a) sufficient revenues from taxpayers to build a financial base that is unencumbered, (b) funds held in reserve that could act as a financial base sufficient to generate necessary income to fund projects, or (c) new capital sources that could take over funding responsibilities thereby relieving the municipality of the financial burden to fund projects. Therefore, the problem that has taken years to create must be solved over time, beginning with a few simple steps.

Assuming a state had a yearly tax revenues of $10 billion dollars, if $2 billion were saved each year, by the end of the 10^{th} year the state would have in excess of $30 billion dollars in the general fund (based on growth of principal from interest earned at a rate of 5% per year).

This means that by the end of the tenth year the state could increase services by $1.5 billion per year, without touching principal, or it could reduce taxes by $1.5 billion without reducing services.

Of course, with most state budgets already overburdened, how does a state save 20% of its tax revenues? It may not be able to, which brings us to the next possibility.

There are one of two ways to reduce spending. The first is to reduce services. Not a particularly good idea in today's society. The second is to allow other organizations to foot the bill thereby reducing the need for spending. This is where the greatest number of innovative concepts can be applied.

Most municipal legislators are typically only familiar with a few financing structures such as municipal bonds, participation partnerships, and lotteries. These structures are designed to attract outside capital, usually from individuals with disposable wealth, who are willing to risk funds in hopes of receiving a return or a percentage of profits. For example, a municipal bond is a financial structure designed to allow pubic investors the opportunity to invest into a municipality while receiving a return of principal and a yearly tax free income during the period of time their funds are being used.

In addition, many states have created public/private partnerships. With public/private partnerships the municipality is in charge of all aspects of the project.

The current invention is a cooperative agreement between a government agency and a private sector organization that runs, owns, or manages the project. Similar to a public utility, private investors provide the funding and private companies provide the management. At most, the state or municipality creates an overview committee to insure the project is run in the best interests of the end users. Ideal for real estate construction such as hospitals, sports stadiums, convention centers, and office buildings, as well as for public utilities, toll bridges, toll roads, and airports, this new strategy allows municipalities to share in the revenues of a project, without having to pay for the construction, operation, maintenance and upkeep. This strategy can also be used to fund light rail systems, educational facilities, prisons, and other revenue or profit oriented projects.

### AN EXAMPLE USING THE CONCEPTS TO FUND A LIGHT RAIL SYSTEM

In simple terms the following concept centers on the creation of a Private Placement for the purposes of funding the construction of a light rail system. The partnership operates under a “Preservation of Principal” concept that returns a portion or all or of investor's principal after a predetermined number of years. The return of principal is (a) backed by the equivalent of investment grade or government bonds and, (b) is unrelated to the revenues of the project. Finally, and most importantly, the structure allows investors to pay for their investment in cash, securities, including 144 Restricted Stock.

The funding does not come from any state or municipal entity. This whole package is accomplished privately. What makes it so beneficial is the underlying state or municipality does not have to use its tax dollars for funding. More importantly, as stated before, the savings could be used to reduce taxes, increase services, or fund more socially focused projects that would not normally be attractive to private investors.

Once completed, the financial package creates sufficient capital to complete construction without debt, government funding, or taxes. There is no need for referendums seeking voter approval, special commissions or management committees overseeing project development. In fact, the only participation the recipient municipality may have is in sharing in a portion of the revenues.

“Preservation of Principal” Operating Concept

What makes the current invention unique is that it can be structured to operate under a “Preservation of Principal (POP)” concept that substantially mitigates the financial risks normally associated with an investment into a new venture. In many cases, the “POP” concept would limit the investor's financial risk by as much as 50% to 95% of the investor's initial capital contribution. This attracts investors who might otherwise be unwilling to assume the risks associated with an investment in a project such as a light rail system.

Most investors pay for their investments in cash. The difficulty is that this requires investors to use after tax dollars. In addition it depletes the investor's cash reserves, and most importantly, requires the partnership to compete with other investments that are being considered by the investor, some of which may be substantially stronger in terms of revenue or profit generation.

In the present example, the light rail development concept allows investors to pay with low basis securities, and most importantly, Rule 144 Restricted Stock (RS). To understand the impact of allowing owners of RS to use their securities as a means of payment one must first understand Restricted Stock.

Commonly called Rule 144 stock, letter stock, or legend stock, Restricted Stock is common stock owned by insiders, control persons, senior management, and others who control or run the largest corporations in America. The regulations that govern how such stock may be sold are part of the Act of 1933/34 as amended in 1972, and are headed under Rule 144/145.

As a result of the process in which they acquired such stock, such as an IPO, most owners of Restricted Stock have an extremely low cost basis. However, they are typically faced with two major restrictions. First, they must wait a minimum one year after an offering before any shares can be sold, and thereafter, they can only sell 1% of the total shares outstanding in any quarter. In addition, insiders cannot do any kind of a “presale,” such as purchasing put options, selling call options, or using their stock as collateral. Rule 144 regulations are designed to prevent insiders from taking advantage of their unique position of having advanced details of a company's operations, not normally available to public shareholders. Were it not for the restrictions, insiders might sell or attempt to monitize their securities just prior to a negative public announcement.

These limitations cause problems for owners of restricted securities, including: (a) it may take the owner of Restricted Stock a long period of time to liquidate his or her holdings, especially considering the 1% per quarter limitation, (b) during the period of time the RS owner is waiting to sell, the stock could decline in price, and (c) the seller has virtually no liquidity, i.e., he or she can't use the stock for any purpose. Therefore, while a Restricted Stockowner may show substantial assets on paper, he or she may be “cash poor.”

However, under Rule 144 Restricted Stock may be exchanged or used for the purposes of making a purchase or investment provided the new owner (in our case, the light rail project Private Placement) is willing to maintain the same restrictions as the original owner, i.e., the partnership will not sell more than 1% of the total shares outstanding in any quarter.

The key to using Restricted Stock has to do with the difference between an “Affiliate, and a Non-Affiliate. When Restricted Stock is used to purchase partnership units the new owner, the partnership, is considered a Non-Affiliate. As long as the partnership is not managed by the original owner of the stock, and the amount of stock contributed is less than 10% of the total shares outstanding, the partnership can monitize the securities in order to raise the necessary capital.

It is important to recognize that the potential marketplace for Restricted Stock is enormous. Every public company that is in existence has owners and key executives who possess wealth in the form of Restricted Stock. With more than 60,000 public companies to choose from, there is a large potential investment pool available. According to recent reports, the Restricted Stock marketplace represents more than $4 trillion dollars of stock value.

The last reason a project manager should focus on this area to attract potential investors is that in the realm of Restricted Stock a minimum unit price of $10 million is not a large amount. Many owners of RS posses' substantially greater sums. Therefore, finding 100 investors (the limit by law) willing to put up $10 million in stock in order to raise $1 billion dollars needed for a project is far easier than attracting 100 investors willing to put up a minimum of $10 million in cash. Even owners of $50 million in stock is not uncommon for Restricted Stock holders, which means as much as $5 billion or more could be raised.

While somewhat of an oversimplification the key elements center on how the concept allows the investor to (a) receive an assurance of a return of principal, (b) participate in project revenues, and (c) use his or her Restricted Stock as a means of payment.

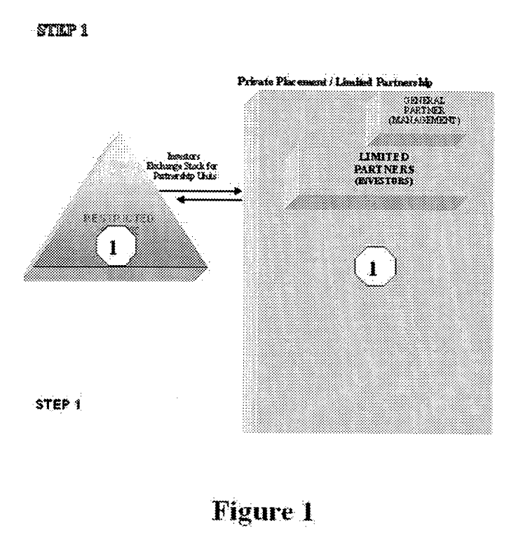

In Step 1, as shown in FIG. 1, a Private Placement/Limited Partnership is formed and owners of Restricted or low basis stock are allowed to exchange their securities for units of Private Placement. As with any Private Placement the investors become the Limited Partners, whereas the project owner/manager is the General Partner.

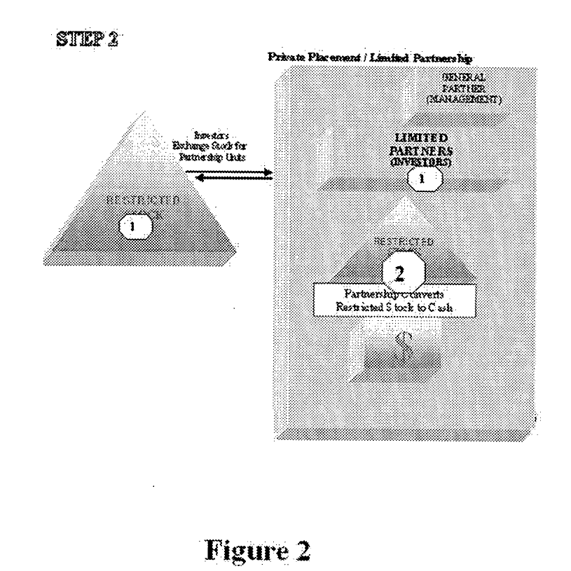

Step is shown in FIG. 2, once the exchange (stock for units) is consummated, the Private Placement becomes the new owner of the Restricted Stock. Because the Partnership would own less than 10% of any issuing company's securities, have no inside knowledge of the company's operations, and would not be able to influence the company in any manner as a control person, it would not be considered an “affiliate.” Therefore, as a “non-affiliate,” the partnership would be entitled to liquidate, hedge, and/or collateralize the securities, i.e., convert the stock to cash.

Converting the stock to cash can be accomplished in a number of ways. For example, a series of “option collars” on the Restricted securities might be instituted thereby creating a “credit” that is released to the partnership. “Collars” are combinations of puts and calls centered on an underlying security and are created with mathematical certainty. The underlying stock can decline, advance, or stand still with no impact on the overall position. In other words, they are structured in such a manner as to offer risk free income, which in the case of a “collar”, is released up front.

While many of the conversion strategies are complex they all have the effect of purchasing a form of protection that shields the investor's original capital contribution. In other words, a premium is paid to assure a return of capital. While this is far too costly for investors using cash, it is ideal for Restricted Stock owners who have a zero cost base and virtually no liquidity.

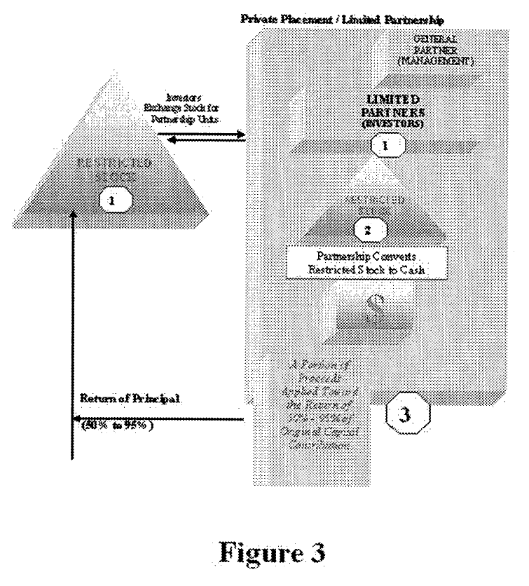

Step 3 is shown in FIG. 3. Depending upon the method used to provide protection, the overall position can be calculated to return 50%-95% of the investor's original capital contribution while still allowing for the complete funding of the project.

The key element to the concept has to do with the amount of Restricted Stock contributed to the partnership or the amount of time before principal is returned to the investors. If principal must be returned in a shorter period of time, for example in five years, the amount returned would be closer to the 50% figure. If the partnership has a longer period of time before it must return principal the figure would be closer to 95%. All this is dependent upon market conditions at the time of the offering, and the decisions of the general partners.

Returning to the fact that the partnership uses a portion of the proceeds to “purchase” protection of the investor's principal, the obvious question becomes, why would an owner of Restricted Stock be willing to give up such a high amount of stock for a lower level of contribution to the project, especially if the project offers real potential for growth? Most investors want the maximum participation to achieve maximum profits.

The answer has to do with the fact that the concept allows the investor to use Restricted Stock. Remember, Restricted Stock is illiquid to the owner. For the most part, such stock sits in an account waiting to be sold. However, since the stock cannot be sold above the 1% per quarter limitation, it may take the owner a substantial number of years before the stock can be completely liquidated. During this waiting period, the stock may not earn any income and more importantly, it could decline in price.

By exchanging stock for partnership units a number of positive things happen for the investor. First, the illiquid stock can now be used to invest into a light rail project that can potentially generate an income. Second, as there is a construction element in the project, the contributed stock can be used to create equity. Third, as the light rail project does not have to use revenues to pay back principal, the project generates greater income for everyone concerned, including the investor. Lastly, the process stabilizes the dollar value of the contributed stock. If the investor's stock declines in price it has no effect on the contributed dollar value of the securities which have been preserved as a result of the financial process. In fact, under certain conditions, the partnership structure can actually allow a profit participation if the underlying stock advances in price.

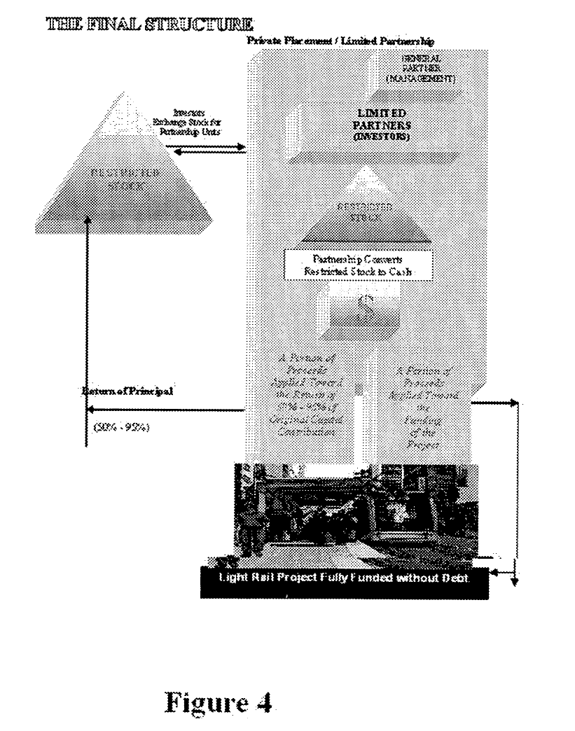

In short, owners of Restricted Stock like this type of structure because they (a) don't have to use cash, (b) don't have to worry about their contribution amount declining in value, and (c) can put their illiquid stock into play to achieve income and growth. The final structure is displayed in FIG. 4.

Advantages

Allowing owners of Restricted Stock the opportunity to exchange their securities for a project partnership is highly beneficial. For example:

The value of the contributed stock is stabilized. Under normal conditions a major decline could wipe out the majority of a Restricted Stock owner's wealth, or delay for years the opportunity to lock in profits. By allowing RS owners the opportunity to exchange shares for units of a partnership, especially one that plans on preserving principal, the investor is able to “freeze” the value of his or her holdings at today's prices and convert stock to cash in a specified number of years.

If certain financial strategies are used there may no taxes due on the Restricted Stock exchange until the final year. This reduces overall taxes on the Restricted Stock sale.

Restricted Stock owners are able to diversify holdings and potentially generate income and profits on stock that currently has no liquidity and does not generate income.

Owners are not limited to Rule 144's maximum quarterly allowance and can make an investment into the Partnership above and beyond 1% per quarter. This allows for effective estate planning and cash management.

Project owners don't have to use their own money to fund the project. Project revenues are not required to pay back investors. The financial structure pays back principal. This enables the project to achieve financial success at an accelerated rate.

There is no debt. The project is free and clear. The first dollars earned generate profits, and do not have to be used to pay back investors.

The investor pool is enormous. The Restricted Stock marketplace is estimated in excess of four trillion dollars. Every public company has multiple owners who possess Restricted Stock. This enables the project manager to approach a large, mostly untapped, investment source.

The State or municipality does not have to pay for the project. Project revenues can be shared with the state and municipality. This new source of income can be applied to reduce deficits and taxes, or toward funding other worthwhile projects.

Because this is a true public/private partnership the State and/or municipality develops long term relationships with investors who possess enormous wealth. As stated before, the Restricted Stock marketplace is large. This pool can be tapped in others ways too numerous to mention in this report.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A financing method comprising:
using a preservation of principal.

2. A financing method according to claim 1 further comprising using restricted stock.

3. A financing method according to claim 1 further comprising being used to raise funds for a private entity.

4. A financing method according to claim 1 further comprising being used to raise funds for a public entity.

5. A financing method according to claim 1 further comprising using financial structure in the process of raising capital for a project with a method to mitigate risk.

6. A financing method according to claim 5 further comprising said financial structure consists of one or more from a group of private placements, limited partnerships or Limited Liability Companies.

7. A financing method according to claim 5 further comprising said projects consist of one or more from a group of private, public or charitable projects.

8. A financing method according to claim 5 further comprising said method to mitigate risk consists of one or more from a group of option purchases and sales, combination positions such as option “collars,” “Variable Forward Sales,” “Prepaid Forward Sales,” and other techniques such as “Shorting Against the Box”, discounted security purchases, equity swaps, option writing, and option spread.

9. A financing method according to claim 1 further comprising having an investor pay for or exchange for partnership interest for something other than cash.

10. A financing method according to claim 9 further comprising having an investor pay for or exchange for partnership interest for one or more from a group of low bases securities or restricted stock.

11. A financing method according to claim 1 further comprising using financial structure in the process of raising capital for a project with a method to mitigate risk consisting of one or more from a group of put option purchases, option “collars,” variable forward sales “VFS's,” “prepaid forward sales,” or any variation thereof, and other combined positions that may include shorting stock “against the box,” the purchase of discounted securities, or other hedged, or arbitraged positions that provide protection to the investor's capital contribution.

12. A financing method according to claim 1 further comprising spending only income earned from the investment principal.

13. A financing method comprising:
using a preservation of principal using financial structure in the process of raising capital for a project with a method to mitigate risk having an investor pay for or exchange for partnership interest for something other than cash where said financial structure consists of one or more from a group of private placements, limited partnerships or Limited Liability Companies where said projects consist of one or more from a group of private, public or charitable projects where said method to mitigate risk consists of one or more from a group of option purchases and sales, combination positions such as option “collars,” “Variable Forward Sales,” “Prepaid Forward Sales,” and other techniques such as “Shorting Against the Box”, discounted security purchases, equity swaps, option writing, and option spread.

14. A financing method according to claim 13 further comprising using restricted stock.

15. A financing method according to claim 13 further comprising having an investor pay for or exchange for partnership interest for one or more from a group of low bases securities or restricted stock.

16. A financing method according to claim 13 further comprising using financial structure in the process of raising capital for a project with a method to mitigate risk consisting of one or more from a group of put option purchases, option “collars,” variable forward sales “VFS's,” “prepaid forward sales,” or any variation thereof, and other combined positions that may include shorting stock “against the box,” the purchase of discounted securities, or other hedged, or arbitraged positions that provide protection to the investor's capital contribution.

17. A financing method according to claim 1 further comprising spending only income earned from the investment principal.
